(19) United States
(12) Patent Application Publication
(10) Pub. No.: US 2025/0259497 A1
(43) Pub. Date: Aug. 14, 2025

(54) Pay as you Go enabled Refrigerator

(71) Applicant: Devidayal Solar Solutions Pvt Ltd, Mumbai (IN)

(72) Inventors: Tushar DEVIDAYAL, Mumbai (IN); Semonti TUPE, Mumbai (IN)

(21) Appl. No.: 19/051,211

(22) Filed: Feb. 12, 2025

(30) Foreign Application Priority Data
Feb. 12, 2024 (IN) 202421009406

(51) Int. Cl. G07F 17/00; F25D 29/00; G07F 9/00; G07F 9/10

(52) U.S. Cl. CPC G07F 17/0021; F25D 29/00; G07F 9/006; G07F 9/105

(57) ABSTRACT

Embodiments herein disclose a tamperproof refrigerator (100) with pay-as-you-go enabled. The refrigerator (100) comprises a pay-as-you-go controller (101A), wherein the pay-as-you-go controller (101A) is integrated with an inbuilt digital display (101B) on the refrigerator (100). The pay-as-you-go controller (101A) is configured to control a compressor (102) of the refrigerator (100) based on a user input and a subscription status related to a pay-as-you-go feature. Further, the pay-as-you-go controller (101A) is integrated with a digital display (101B) on the refrigerator (100), and a keyboard (101D), and is configured to control the compressor (102) of the refrigerator (100).

### CROSS REFERENCE TO RELATED APPLICATION

This application is based on and derives the benefit of Indian Provisional Application IN 202421009406, the contents of which are incorporated herein by reference.

### TECHNICAL FIELD

Embodiments disclosed herein relate to refrigerators, and more particularly to tamperproof refrigerators with pay-as-you-go enabled.

### BACKGROUND

Currently, pay-as-you-go is a feature that has been enabled in multiple devices and services, such as in, solar distribution, refrigerators, renewable energy distribution, solar lighting, solar home systems, solar cooking, agriculture, solar home appliances, and so on. Pay-as-you-go enables users to use features/services as required, while keeping their costs low.

In appliances, such as refrigerators, pay-as-you-go has been enabled using a separate module/controller in the refrigerator. However, this leads to scenarios, wherein a user can tamper with the refrigerator by removing/disabling the pay-as-you-go module/controller, while the refrigerator continues to operate normally.

Hence, there is a need in the art for solutions which will overcome the above mentioned drawback(s), among others.

### OBJECTS

The principal object of embodiments herein is to disclose a tamperproof refrigerator with pay-as-you-go enabled, wherein a pay-as-you-go controller is integrated with an inbuilt digital display on the refrigerator, and is configured to control a compressor of the refrigerator.

Another object of embodiments herein is to disclose a tamperproof refrigerator with pay-as-you-go enabled, wherein a pay-as-you-go controller is integrated with a digital display on the refrigerator, and a keyboard, and is configured to control a compressor of the refrigerator.

Another object of embodiments herein is to disclose a tamperproof refrigerator enabled with a pay-as-you-go feature, wherein a pay-as-you-go controller is configured to control the compressor of the refrigerator based on one or more user inputs, and a subscription status related to the pay-as-you-go feature.

### SUMMARY

Accordingly, the embodiments herein provide a refrigerator comprising a compressor, and a control and display module. The control and display module is connected to the compressor. The control and display module is enabled with a pay-as-you-go feature, and configured to operate the compressor based on at least one of a user input and a subscription status related to the pay-as-you-go feature.

Accordingly, the embodiments herein provide a method for operating a refrigerator implemented with a pay-as-you-go feature. The method comprises receiving, by a control and display module of the refrigerator, at least one of a pay-as-you-go token and one or more pay-as-you-go user credentials from a user. The method comprises authenticating, by the control and display module, at least one of the received pay-as-you-go token and one or more pay-as-you-go user credentials. Thereafter, the method comprises operating, by the control and display module, a compressor if authentication of at least one of the pay-as-you-go token and one or more pay-as-you-go user credentials is successful. The method comprises sending, by the control and display module, a failure notification to the user if authentication of at least one of the pay-as-you-go token and one or more pay-as-you-go user credentials is failed.

Accordingly, the embodiments herein provide a refrigerator comprising a compressor, and a control and display module. The control and display module is connected to the compressor. The control and display module is enabled with a pay-as-you-go feature. The control and display module is configured to receive at least one of a pay-as-you-go token and one or more pay-as-you-go user credentials from a user. The control and display module is configured to authenticate at least one of the received pay-as-you-go token and one or more pay-as-you-go user credentials. The control and display module is configured to operate a compressor if authentication of at least one of the pay-as-you-go token and one or more pay-as-you-go user credentials is successful. Further, the control and display module is configured to send a failure notification to the user if authentication of at least one of the pay-as-you-go token and one or more pay-as-you-go user credentials is failed.

Accordingly, the embodiments herein provide a method for managing one or more operations of a refrigerator implemented with a pay-as-you-go feature. The method comprises monitoring, by a control and display module of the refrigerator, a subscription status of the pay-as-you-go feature of a user. The method comprises operating, by the control and display module, a compressor of the refrigerator if the subscription status of the pay-as-you-go feature of the user is permitted. Thereafter, the method comprises sending a failure notification to the user if the subscription status of the pay-as-you-go feature of the user is not permitted.

Accordingly, the embodiments herein provide a refrigerator comprising a compressor, and a control and display module. The control and display module is connected to the compressor. The control and display module is enabled with a pay-as-you-go feature. The control and display module is configured to monitor a subscription status of the pay-as-you-go feature of a user. The control and display module is configured to operate the compressor if the subscription status of the pay-as-you-go feature of the user is permitted. Further, the control and display module is configured to send a failure notification to the user if the subscription status of the pay-as-you-go feature of the user is not permitted.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 depicts a refrigerator configured with a pay-as-you-go controller, according to embodiments as disclosed herein;

FIG. 2 depicts a refrigerator configured with a pay-as-you-go controller and an inbuilt keyboard, according to embodiments as disclosed herein;

FIG. 3 is a method depicting process of operating a refrigerator equipped with pay-as-you-go, according to embodiments as disclosed herein; and

FIG. 4 is a method depicting the process of managing the operations of the refrigerator equipped with pay-as-you-go, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

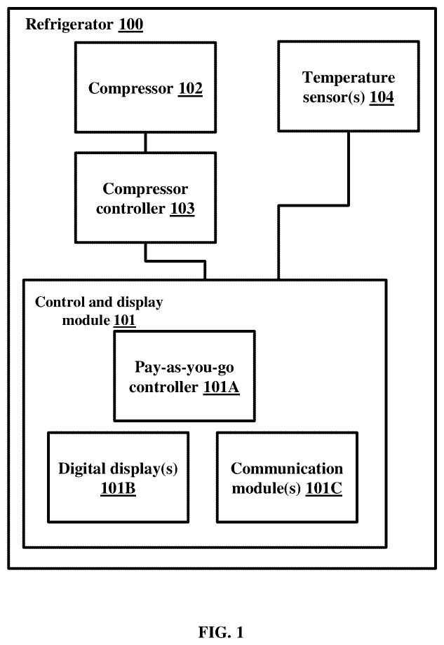

The embodiments herein achieve a tamperproof refrigerator with pay-as-you-go enabled, wherein the pay-as-you-go controller is integrated with an inbuilt digital display on the refrigerator and is configured to control a compressor of the refrigerator. Referring now to the drawings, and more particularly to FIGS. 1 through 4, where similar reference characters denote corresponding features consistently throughout the figures, there are shown embodiments.

FIG. 1 depicts a refrigerator 100 configured with a pay-as-you-go controller. The refrigerator 100, as depicted comprises a control and display module 101, a compressor 102, and a compressor controller 103. The control and display module 101 is connected to the compressor 102, and enabled with a pay-as-you-go feature. The control and display module 101 is configured to operate the compressor 102 based on at least one of a user input and a subscription status related to the pay-as-you-go feature. The control and display module 101 further comprises a pay-as-you-go controller 101A, one or more digital displays 101B, and one or more communication modules 101C. In an embodiment herein, the pay-as-you-go controller 101A, the one or more digital displays 101B, and the one or more communication modules 101C can be implemented on a single microcontroller, wherein the microcontroller is hardcoded with a unique identification (ID) and is paired with the refrigerator 100.

In an embodiment herein, the pay-as-you-go controller 101A is configured to control the compressor 102 based on at least one of a user input and a subscription status related to the pay-as-you-go feature. The pay-as-you-go controller 101A can control at least one of a speed start, and stop modes of the compressor 102. The subscription status of the pay-as-you-go feature comprises at least one of time left on a user's subscription, and time used by the user on the user's subscription. The pay-as-you-go controller 101A of the control and display module 101 receives the subscription status of the pay-as-you-go feature of the user from a pay-as-you-go server.

In an embodiment herein, the control and display module 101 is hardcoded with a unique ID, and is paired with the refrigerator 100. The control and display module 101 may comprise one or more microprocessors, circuits, and other hardware configured for processing. The control and display module 101 can be configured to execute instructions.

The control and display module 101 can be at least one of a single processor, a plurality of processors, multiple homogeneous or heterogeneous cores, multiple Central Processing Units (CPUs) of different kinds, microcontrollers, special media, and other accelerators. The control and display module 101 may be an Application Processor (AP), a graphics-only processing unit such as a Graphics Processing Unit (GPU), a Visual Processing Unit (VPU), and/or an Artificial Intelligence (AI)-dedicated processor such as a Neural Processing Unit (NPU).

The one or more digital displays 101B can display information, such as, but not limited to, the temperature of the refrigerator 100, battery State of Charge (SOC) levels (if applicable), whether pay-as-you-go is enabled/disabled, how much time (in years, months, days, hours, minutes, and so on) is left based on a users' subscription, how much time (in years, months, days, hours, minutes, and so on) has been used by the user, based on a users' subscription to pay-as-you-go, power on/off status, a current compressor mode, current status of a battery protection setting switch, operational settings of the refrigerator 100, and so on.

In an embodiment herein, the one or more digital displays 101B can comprise one or more lights, wherein the lights can be used for providing information to the user, wherein the signals can be pre-defined and made available to the user.

In an embodiment herein, the one or more communication modules 101C are configured to enable communication between the refrigerator 100 and at least one external entity (such as, but not limited to, a pay-as-you-go server, one or more user devices, other devices in a same communication network (to which the refrigerator 100 is connected), and so on, and so on)) through a network or cloud. The one or more communication modules 101C may communicate in the form of either a wired network, a wireless network, or a combination thereof. Examples of the wired and wireless communication networks can be, but are not limited to, Global Positioning System (GPS), Global System for Mobile Communications (GSM), Local Area Network (LAN), Wireless Fidelity (Wi-Fi) compatibility, Bluetooth Low Energy (BLE), Near-field Communication (NFC), and so on. Examples of the wireless communication may comprise one or more of Bluetooth, Zonal Intercommunication Global Standard (ZigBee), short-range wireless communication (such as, but not limited to, Ultra-wideband (UWB)), medium-range wireless communication (such as, but not limited to, Wi-Fi), or long-range wireless communication (such as, but not limited to, Third Generation (3G), Fourth Generation (4G), or Worldwide Interoperability for Microwave Access (WiMAX), satellite communications, and so on), according to the usage environment.

The control and display module 101 can further comprise one or more user interfaces, such as, but not limited to, one or more buttons/interfaces (which can be at least one of physical switches, touchpads, touch screens, and so on) (not shown), which can enable a user to control one or more functionalities of the refrigerator 100. Examples of the functionalities can be, but not limited to, setting a temperature for the freezer, setting a temperature for the remaining portion of the refrigerator 100, powering the refrigerator 100 on/off, setting the cooling levels of the refrigerator 100, compressor mode, and so on.

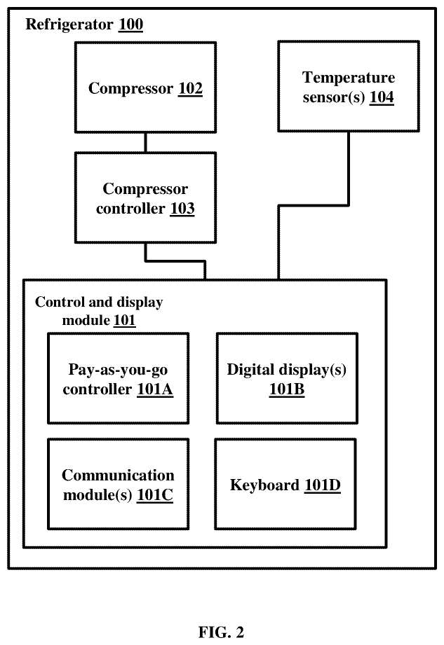

In an example depicted in FIG. 2, the control and display module 101 further comprises a user interface where he user interface is a keyboard 101D. The user can use the keyboard (101D) to provide one or more user inputs to the refrigerator 100, such as, but not limited to, a pay-as-you-go token, one or more pay-as-you-go user credentials, and so on. In an embodiment herein, the keyboard 101D can be at least one of a physical keyboard, and a touchscreen based keyboard. In an embodiment herein, the pay-as-you-go controller 101A, the compressor controller 103, and the one or more digital displays 101B, the one or more communication modules 101C, and the keyboard 101D can be implemented on a single microcontroller.

In an example, the user can provide one or more inputs to the refrigerator 100, such as, but not limited to, a pay-as-you-go token, pay-as-you-go credentials, and so on, using the communications module 101C. In an embodiment herein, the communication module 101C can enable the refrigerator 100 to communicate with at least one external device/entity, such as a pay-as-you-go server, one or more user devices, other devices in a same communication network (to which the refrigerator 100 is connected), and so on. In an embodiment herein, the communication module 101C can use at least one of Bluetooth, Bluetooth low energy (BLE), Wi-Fi, cellular networks, and so on, to communicate with the at least one external device/entity and/or the user.

In an embodiment herein, the control and display module 101 can be connected to one or more temperature sensors 104 in one or more compartments of the refrigerator 100, wherein the control and display module 101 can control the compressor 102 based on inputs from the one or more temperature sensors 104.

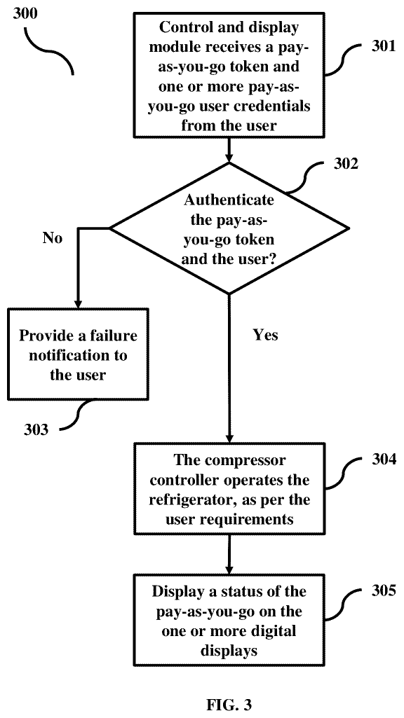

FIG. 3 is a method 300 depicting process of operating a refrigerator 100 equipped with pay-as-you-go. In step 301, the control and display module 101 receives a pay-as-you-go token from the user. In an embodiment herein, the control and display module 101 receives the pay-as-you-go token and one or more pay-as-you-go user credentials from the user using the keyboard 101D. The pay-as-you-go user credentials can be pre-configured by the user. In an embodiment herein, the control and display module 101 receives the pay-as-you-go token from the user via the communication module 101C. In step 302, the control and display module 101 authenticates the pay-as-you-go token, and the user via one or more pay-as-you-go user credentials. In an embodiment herein, authenticating the pay-as-you-go token and the user involves the pay-as-you-go controller 101A communicating with an internal memory (not shown) for checking if the pay-as-you-go token is authentic, and if the received pay-as-you-go token has been assigned to this user. If the control and display module 101 is unable to authenticate the pay-as-you-go token and/or the user and is failed, in step 303, the control and display module 101 provides a failure notification to the user using at least one of the one or more digital displays 101B, and to one or more user devices via the communication module 101C. If the control and display module 101 is able to successfully authenticate the pay-as-you-go token and/or the user, in step 304, the control and display module 101 provides instructions to the compressor controller 103 to operate the refrigerator 100, as per the user requirements. In step 305, the control and display module 101 further displays a status of the pay-as-you-go on the one or more digital displays 101B, such as, how much time (in years, months, days, hours, minutes, and so on) is left based on a users' subscription (as provided by the server), how much time (in years, months, days, hours, minutes, and so on) has been used by the user, based on a users' subscription, and so on. The various actions in method 300 may be performed in the order presented, in a different order or simultaneously. Further, in some embodiments, some actions listed in FIG. 3 may be omitted.

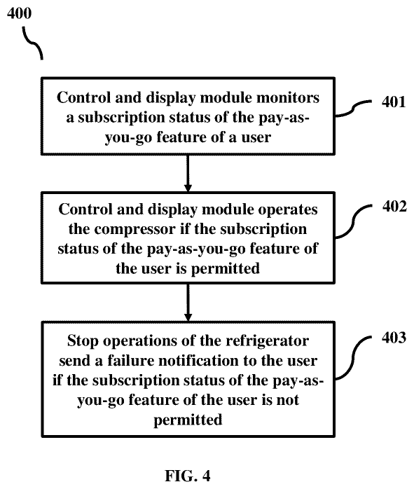

FIG. 4 is a method 400 depicting the process of managing the operations of the refrigerator 100 equipped with pay-as-you-go. In step 401, the control and display module 101 monitors a subscription status of the pay-as-you-go feature of a user, such as, how much time (in years, months, days, hours, minutes, and so on) is left based on a users' subscription (as provided by the server), how much time (in years, months, days, hours, minutes, and so on) has been used by the user, based on a users' subscription, and so on. If the subscription status of the pay-as-you-go feature of the user is permitted, then the control and display module 101 can operate the compressor 102 of the refrigerator 100, as depicted in step 402. If the subscription status of the pay-as-you-go feature of the user is not permitted, to use the refrigerator 100, as depicted in step 403, then the control and display module 101 can provide instructions to the compressor controller 103 to stop operations of the refrigerator 100 and send a failure notification to the user. The various actions in method 400 may be performed in the order presented, in a different order or simultaneously. Further, in some embodiments, some actions listed in FIG. 4 may be omitted.

Embodiments herein enable the refrigerator 100 to be tamperproof, as the refrigerator 100 cannot function without the pay-as-you-go controller 101A, nor do embodiments herein enable users to replace the control and display module 101, as the control and display module 101 and the refrigerator 100 are uniquely coded together.

Embodiments herein enable the usage of the refrigerator 100 and payment behaviour/pattern to be tracked securely.

Embodiments herein enable the user to use the refrigerator 100 for as much time that he requires. For example, if the refrigerator 100 is in his farm house that he visits one weekend every month, the user can use the pay-as-you-go go token for 2 days of the weekend, while he does not have to pay for using the refrigerator 100 for the rest of the month, when he is not in the farmhouse.

The embodiments disclosed herein can be implemented through at least one software program running on at least one hardware device and performing network management functions to control the network elements. The elements include blocks which can be at least one of a hardware device, or a combination of hardware device and software module.

The embodiments disclosed herein describe a tamperproof refrigerator 100 with pay-as-you-go enabled, wherein the pay-as-you-go controller 101A is integrated with an inbuilt digital display 101B on the refrigerator 100, and is configured to control a compressor 102 of the refrigerator 100. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

We claim:

1. A refrigerator comprising:
a compressor; and
a control and display module connected to the compressor, and enabled with a pay-as-you-go feature,
wherein the control and display module is configured to operate the compressor based on at least one of a user input and a subscription status related to the pay-as-you-go feature.

2. The refrigerator as claimed in claim 1, wherein the control and display module is hardcoded with a unique identification (ID), and is paired with the refrigerator, wherein the control and display module comprises at least one of a user interface, a display, and a communication module.

3. The refrigerator as claimed in claim 1, wherein the control and display module is configured to enable communication between the refrigerator and at least one of a pay-as-you-go server, and one or more user devices using the communication module.

4. The refrigerator as claimed in claim 1, wherein the user input comprises at least one of a pay-as-you-go token, and one or more pay-as-you-go user credentials.

5. The refrigerator as claimed in claim 1, wherein the control and display module is configured to:
authenticate at least one of the pay-as-you-go token, and one or more pay-as-you-go user credentials;
operate the compressor, if authentication of the at least one of the pay-as-you-go token, and one or more pay-as-you-go user credentials is successful; and
send a failure notification to the user, if authentication of the at least one of the pay-as-you-go token, and one or more pay-as-you-go user credentials is failed.

6. The refrigerator as claimed in claim 1, wherein the subscription status of the pay-as-you-go feature comprises at least one of time left on a user's subscription, and time used by the user on the user's subscription, wherein the control and display module receives the subscription status of the pay-as-you-go feature of the user from the pay-as-you-go server.

7. The refrigerator as claimed in claim 1, wherein the control and display module is configured to:
monitor the subscription status of the pay-as-you-go feature of the user;
operate the compressor if the subscription status of the pay-as-you-go feature of the user is permitted; and
send a failure notification to the user if the subscription status of the pay-as-you-go feature of the user is not permitted.

8. A method for operating a refrigerator implemented with a pay-as-you-go feature, comprising:
receiving, by a control and display module of the refrigerator, at least one of a pay-as-you-go token and one or more pay-as-you-go user credentials from a user;
authenticating, by the control and display module, at least one of the received pay-as-you-go token and one or more pay-as-you-go user credentials;
operating, by the control and display module, a compressor if authentication of at least one of the pay-as-you-go token and one or more pay-as-you-go user credentials is successful; and
sending, by the control and display module, a failure notification to the user if authentication of at least one of the pay-as-you-go token and one or more pay-as-you-go user credentials is failed.

9. The method as claimed in claim 8, wherein the control and display module is hardcoded with a unique identification (ID), and is paired with the refrigerator, wherein the control and display module comprises at least one of a user interface, a display, and a communication module.

10. The method as claimed in claim 8, wherein the control and display module is configured to enable communication between the refrigerator and at least one of a pay-as-you-go server, and one or more user devices using the communication module.

11. The method as claimed in claim 8, wherein the control and display module is configured to operate the compressor based on a subscription status related to the pay-as-you-go feature.

12. The method as claimed in claim 11, wherein the subscription status of the pay-as-you-go feature comprises at least one of time left on a user's subscription, and time used by the user on the user's subscription, wherein the control and display module receives the subscription status of the pay-as-you-go feature of the user from the pay-as-you-go server.

13. The method as claimed in claim 11, wherein the method comprises:
monitoring, by the control and display module, the subscription status of the pay-as-you-go feature of the user;
operating, by the control and display module, the compressor if the subscription status of the pay-as-you-go feature of the user is permitted; and
sending, by the control and display module, a failure notification to the user if the subscription status of the pay-as-you-go feature of the user is not permitted.
